(19) United States
(12) Patent Application Publication
(10) Pub. No.: US 2007/0025811 A1
(43) Pub. Date: Feb. 1, 2007

(54) Coupling Assembly with Overmold Sealing Structures and Method of Forming the Same

(75) Inventor: Grant Armin Wilhelm, Plymouth, MN (US)

Correspondence Address: MERCHANT & GOULD PC, P.O. BOX 2903, MINNEAPOLIS, MN, 55402-0903, US

(73) Assignee: Colder Products Company, St. Paul, MN (US)

(21) Appl. No.: 11/460,151

(22) Filed: Jul. 26, 2006

Related U.S. Application Data
(60) Provisional application No. 60/702,547, filed on Jul. 26, 2005.

(51) Int. Cl. B25G 3/00

(52) U.S. Cl. 403/300

(57) ABSTRACT

A coupling assembly includes a body and an insert. The insert is introduced into the body to create fluid tight connection therebetween. Overmold seals can be formed in both the body and the insert. In addition, overmold joints can be formed to attach various components of the coupling assembly. A recessed sealing surface on the insert can be used.

### RELATED APPLICATION

This application claims the benefit of U.S. Patent Provisional Application Ser. No. 60/702,547 filed on Jul. 26, 2005, the entirety of which is hereby incorporated by reference.

### TECHNICAL FIELD

Embodiments of the present invention relate to fluid coupling assemblies and methods of making coupling assemblies. More particularly, embodiments of the present invention relate to fluid coupling assemblies with valve structures having overmold seals, and methods of forming the valve structures in the same.

### BACKGROUND

Quick disconnect coupling assemblies are commonly used in fluid transport applications. Coupling assemblies can include a male portion that is introduced into a female portion to create a fluid tight connection. Typically, connectors of such assemblies require proper dimensioning so that seal and/or assembled surfaces can be maintained to provide a no leak connector. These connectors can also employ twist-to-connect or quick connect/disconnect features having manually operated latches for connecting to other pieces of fluid dispensing equipment. Further, valve control parts and assemblies can be employed for controlling fluid flow. Examples of fluid coupling assemblies include those described in U.S. Pat. Nos. 5,494,074 and 5,938,244 and in U.S. patent application Ser. Nos. 10/417,678 and 10/612,475, the entireties of which are hereby incorporated by reference.

Connections and seals between different components of the coupling assemblies can be difficult and expensive to form and/or assemble. For example, in some connectors, o-rings are used to form seals between moving components of the connectors. Welding techniques, such as sonic- or spin-welding, are typically used to attach non-moving components of thermoplastic coupling assemblies.

For connectors that require tight manufacturing tolerances, specific dimensions, the sealing and/or assembled surfaces of the connector can be compromised due to a variety of factors, including variations in tolerances and shrinkage during injection molding processes. These variations can cause leaks and can make it necessary to go back and fine-tune the connector to specification requirements, which can be a costly process.

There is a need for improved coupler assemblies.

### SUMMARY

Embodiments of the present invention relate to fluid coupling assemblies and methods of making coupling assemblies. More particularly, embodiments of the present invention relate to fluid coupling assemblies with valve structures having overmold seals, and methods of forming the valve structures in the same.

According to one aspect, a coupler for a coupling assembly includes a housing defining an internal bore, and a sleeve positioned in the bore of the housing. The coupler also includes a first overmold seal formed to create a sealing engagement between the sleeve and the housing.

According to another aspect, a coupler for a coupling assembly includes a housing including a first end, a second end, and defining an internal bore, wherein the first end defines a recessed sealing surface, and a termination attached to the second end of the housing. The coupler also includes a valve positioned in the bore of the housing.

According to yet another aspect, a method of forming a coupler includes: molding a sleeve of the coupler, the sleeve defining an interior surface, an exterior surface, a first end, and a second end; and overmolding a first seal on the exterior surface of the sleeve to seal against a wall forming an internal bore in a housing of the coupler.

### BRIEF DESCRIPTION OF THE DRAWINGS

Like reference numbers generally indicate corresponding elements in the figures.

FIG. 1 is a cross-sectional view of one embodiment of a coupling assembly showing one embodiment of a coupler body and a coupler insert.

FIG. 2 is a perspective view of the coupler body of the coupling assembly of FIG. 1.

FIG. 3 is a partial sectional perspective view of the coupler body of FIG. 2.

FIG. 4 is an exploded perspective view of the coupler body of FIG. 2.

FIG. 5 is a side view of the coupler body of FIG. 2.

FIG. 6 is an end view of the coupler body of FIG. 5.

FIG. 7 is a side sectional view of the coupler body of FIG. 6 taken along line 7-7.

FIG. 8 is a perspective view of one embodiment of a coupler housing of the coupler body shown in FIG. 4.

FIG. 9 is a side view of the coupler housing of FIG. 8.

FIG. 10 is an end view of the coupler housing of FIG. 8.

FIG. 11 is a side sectional view of the coupler housing of FIG. 10 taken along line 11-11.

FIG. 12 is an enlarged view of a portion of the coupler housing of FIG. 11.

FIG. 13 is a top view of the coupler housing of FIG. 8.

FIG. 14 is an enlarged view of a portion of the coupler housing of FIG. 13.

FIG. 15 is a perspective view of one embodiment of a coupler adapter of the coupler body shown in FIG. 4.

FIG. 16 is a side view of the coupler adapter of FIG. 15.

FIG. 17 is a top view of the coupler adapter of FIG. 15.

FIG. 18 is an end view of the coupler adapter of FIG. 15.

FIG. 19 is a sectional side view of the coupler adapter of FIG. 18 taken along line 19-19.

FIG. 20 is a perspective view of one embodiment of a coupler sleeve of the coupler body shown in FIG. 4 after a first shot mold.

FIG. 21 is a side view of the coupler sleeve of FIG. 20.

FIG. 22 is an end view of the coupler sleeve of FIG. 20.

FIG. 23 is a sectional view of the coupler sleeve of FIG. 22 taken along line 23-23.

FIG. 24 is a perspective view of one embodiment of a coupler sleeve of the coupler body shown in FIG. 4 after a second shot mold.

FIG. 25 is an end view of the coupler sleeve of FIG. 24.

FIG. 26 is a sectional side view of the coupler sleeve of FIG. 25 taken along line 26-26.

FIG. 27 is an enlarged view of a portion of the coupler sleeve of FIG. 26.

FIG. 28 is a perspective view of the coupler insert of the coupling assembly of FIG. 1

FIG. 29 is a partial sectional perspective view of the coupler insert of FIG. 28.

FIG. 30 is an exploded perspective view of the coupler insert of FIG. 28.

FIG. 31 is a side view of the coupler insert of FIG. 28.

FIG. 32 is an end view of the coupler insert of FIG. 28.

FIG. 33 is a sectional side view of the coupler insert of FIG. 32 taken along line 33-33.

FIG. 34 is a perspective view of one embodiment of an insert housing of the coupler insert of FIG. 30.

FIG. 35 is a side view of the insert housing of FIG. 34.

FIG. 36 is a top view of the insert housing of FIG. 34.

FIG. 37 is an end view of the insert housing of FIG. 34.

FIG. 38 is a sectional side view of the insert housing of FIG. 37 taken along line 38-38.

FIG. 39 is an enlarged view of a portion of the insert housing of FIG. 38.

FIG. 40 is a perspective view of one embodiment of an insert adapter of the coupler insert of FIG. 30.

FIG. 41 is a side view of the insert adapter of FIG. 40.

FIG. 42 is an end view of the insert adapter of FIG. 40.

FIG. 43 is a sectional side view of the insert adapter of FIG. 42 taken along line 43-43.

FIG. 44 is a perspective view of an insert valve member of the coupler insert of FIG. 30 after a first shot mold.

FIG. 45 is a side view of the insert valve of FIG. 44.

FIG. 46 is an end view of the insert valve of FIG. 44.

FIG. 47 is a sectional side view of the insert valve of FIG. 46 taken along line 47-47.

FIG. 48 is a perspective view of one embodiment of an insert valve of the coupler insert of FIG. 30 after a second shot mold.

FIG. 49 is an end view of the insert valve of FIG. 48.

FIG. 50 a sectional side view of the insert valve of FIG. 49 taken along line 50-50.

FIG. 51 is a schematic view of one embodiment for a two-shot molding method for making the coupler sleeve of FIGS. 20-27 including a schematic of tooling for the same.

FIG. 52 is a schematic view of one embodiment of an overmold joint between a housing and an adapter of a body of a coupling assembly.

FIG. 53 is a schematic view of second embodiment of an overmold joint between a housing and an adapter of a body of a coupling assembly.

FIG. 54 is a schematic view of third embodiment of overmold an overmold joint between a housing and an adapter of a body of a coupling assembly.

FIG. 55 is a schematic view of one embodiment for an insert molding method for making an overmold joint including a schematic of tooling for the same.

### DETAILED DESCRIPTION

Embodiments of the present invention relate to fluid coupling assemblies and methods of making coupling assemblies. More particularly, embodiments of the present invention relate to fluid coupling assemblies with valve structures having overmold seals, and methods of forming the valve structures in the same.

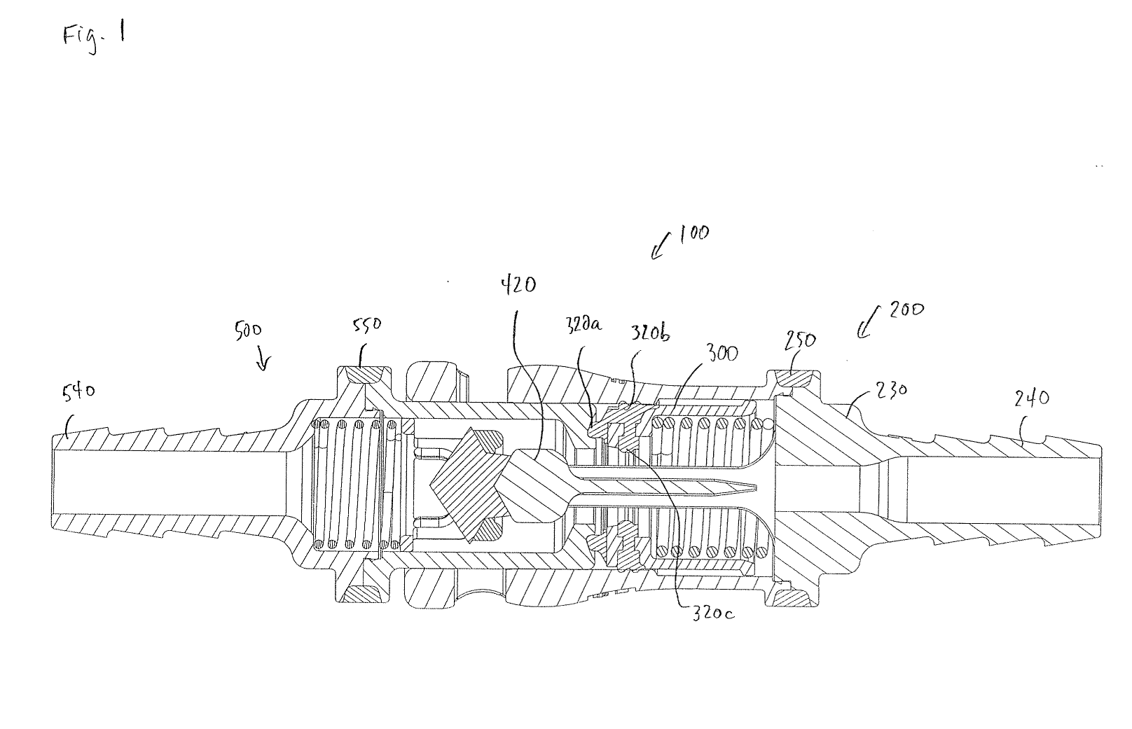

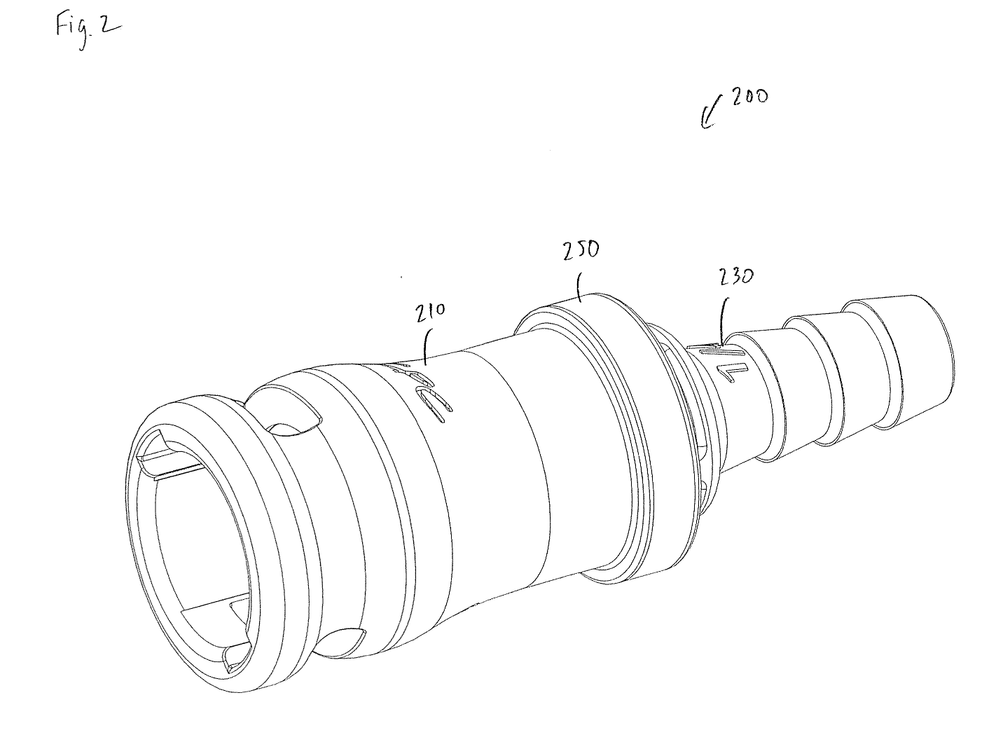

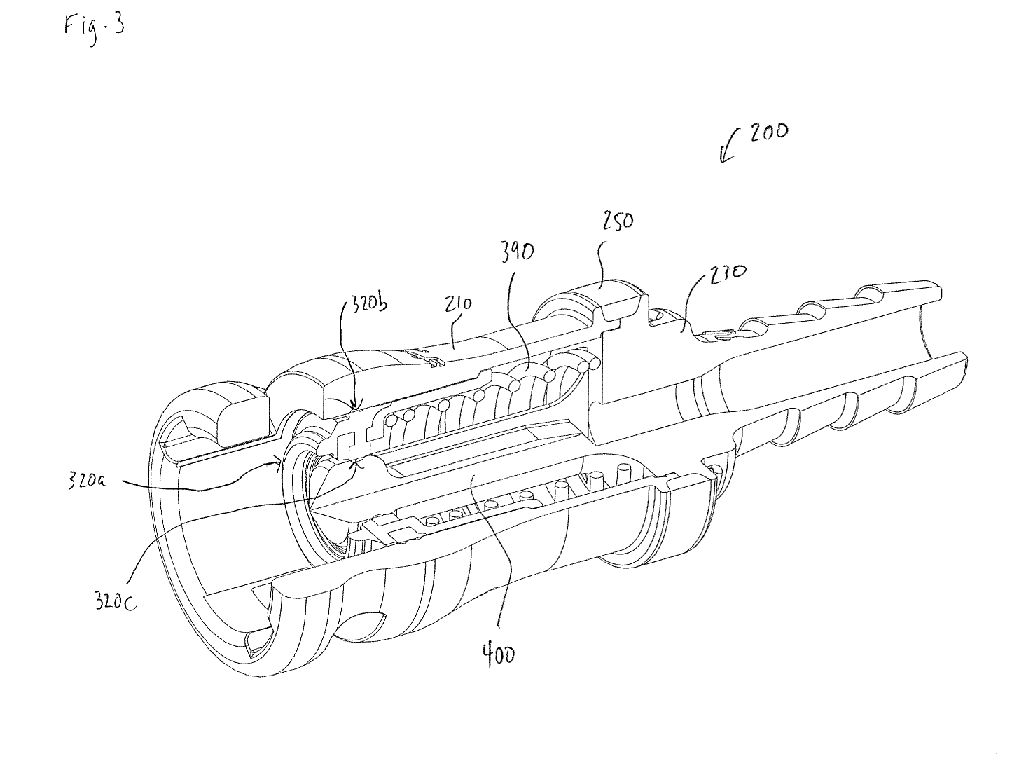

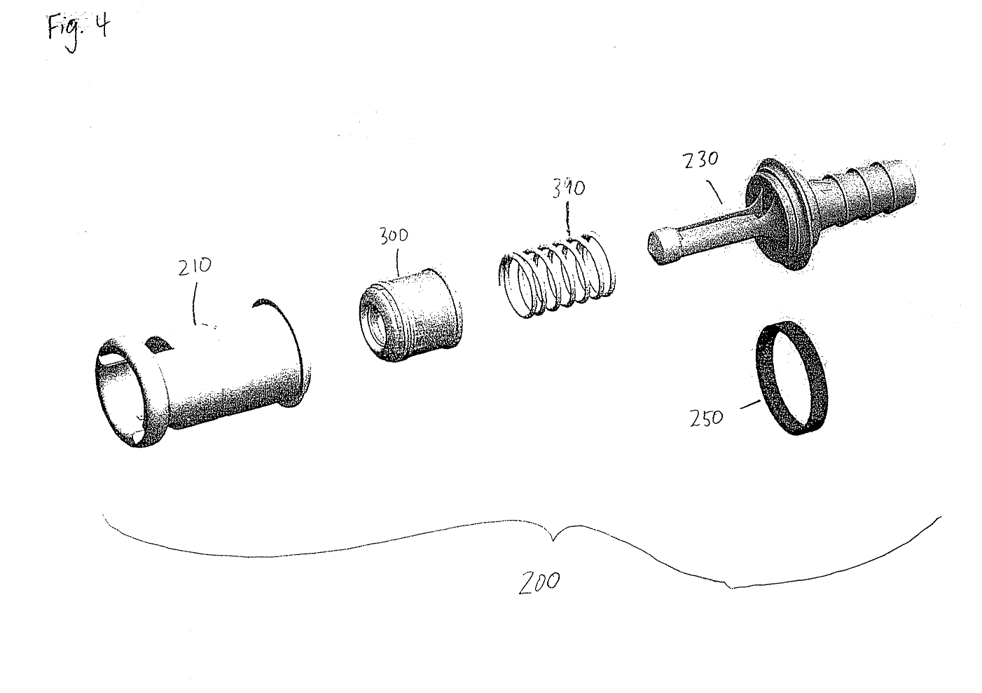

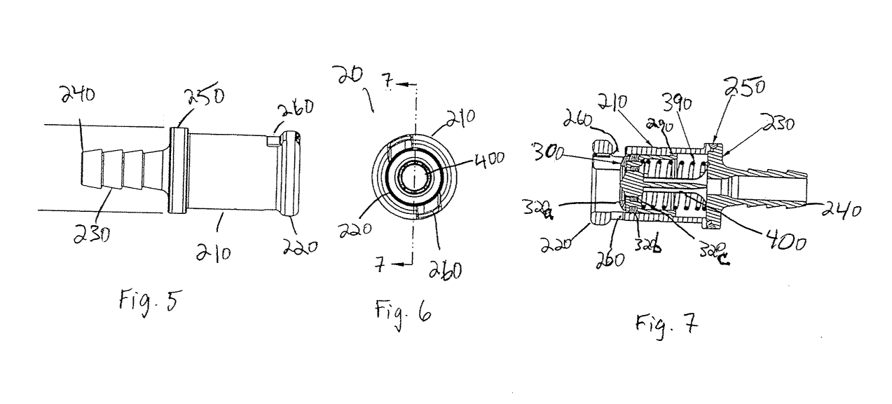

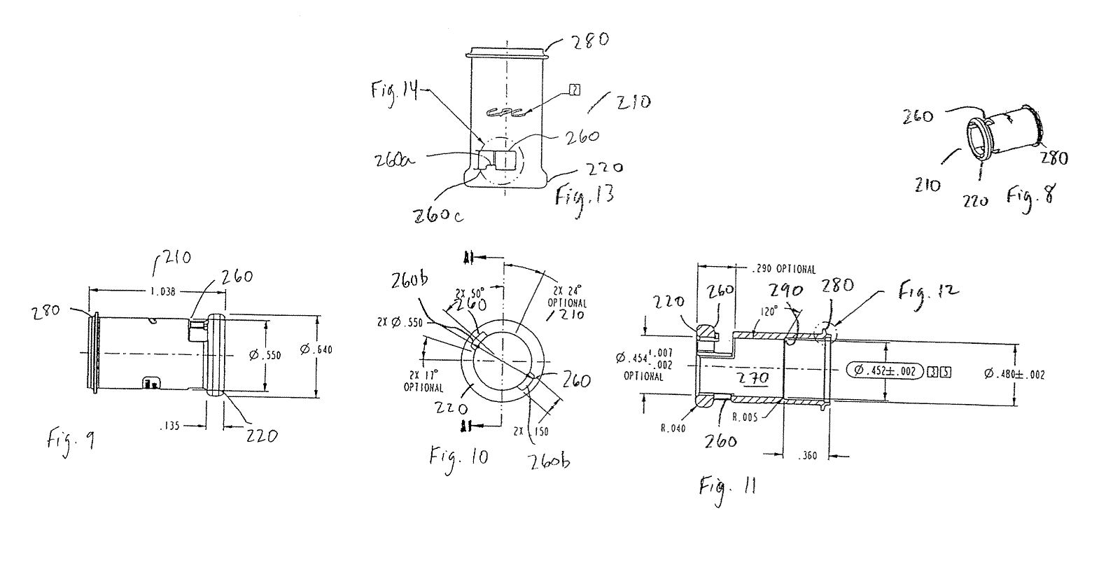

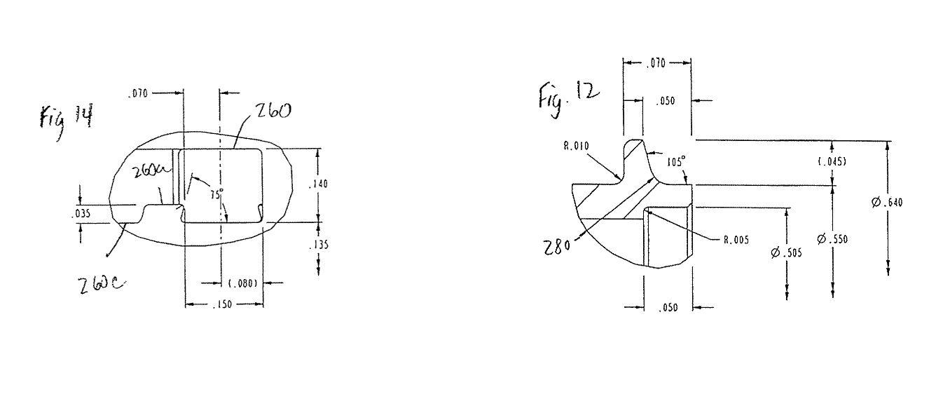

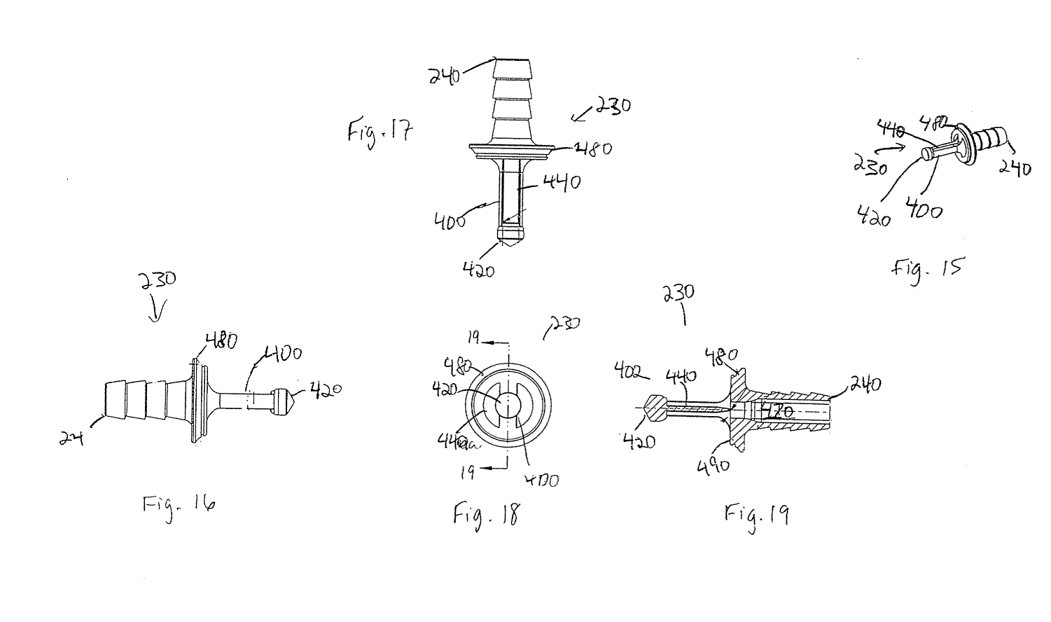

One embodiment of a coupling assembly 100 is shown in FIG. 1. Assembly 100 generally includes a coupler body 200 and a coupler insert 500. Insert 500 is introduced into body 200 as shown in FIG. 1 to form a fluid tight connection therebetween.

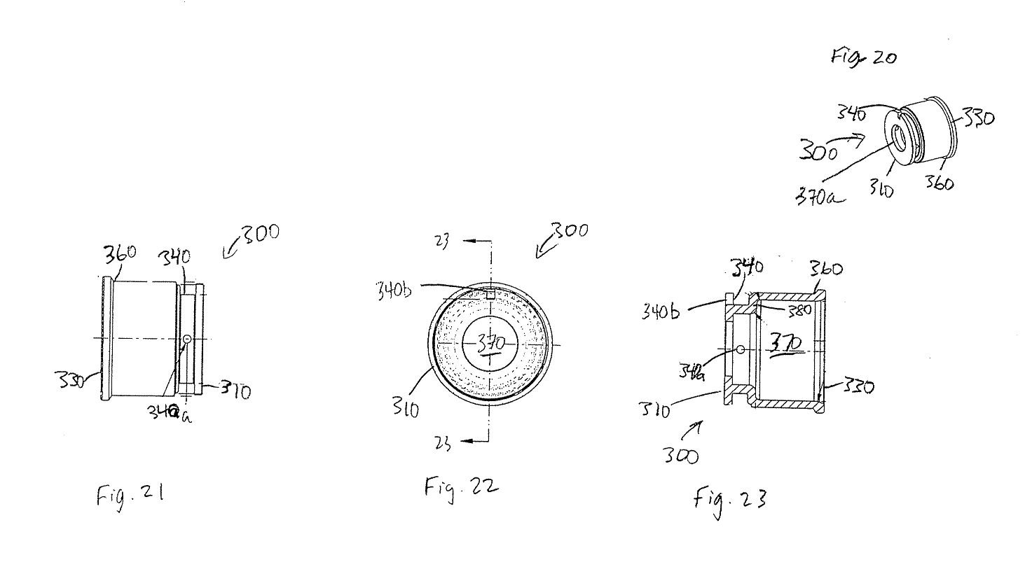

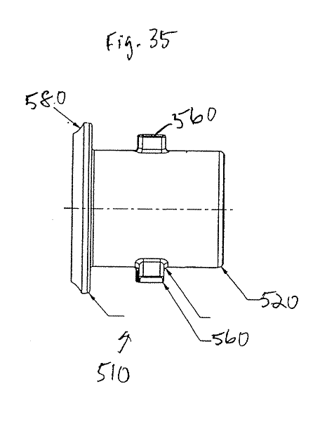

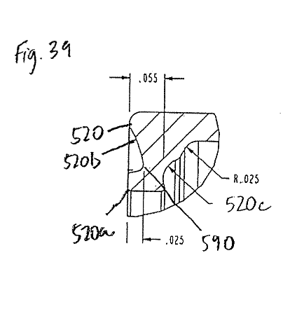

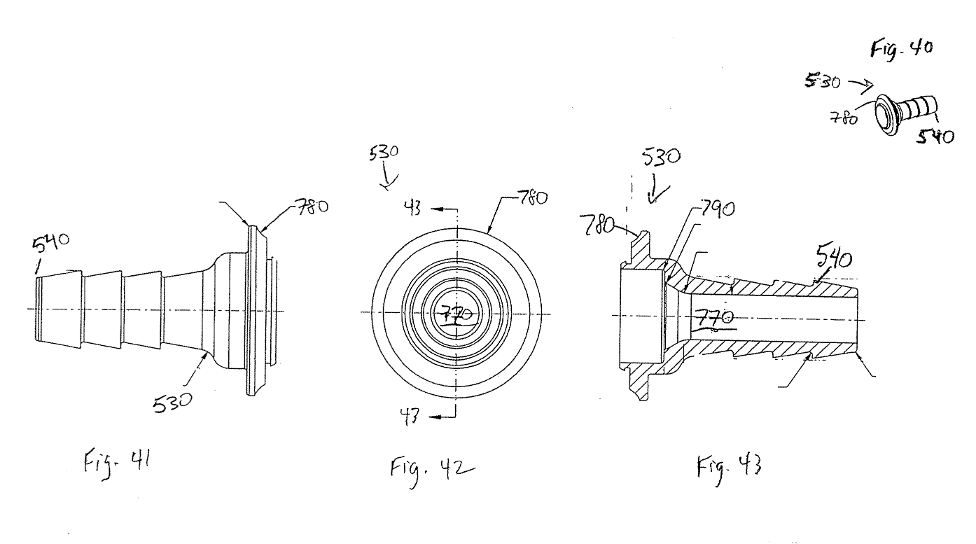

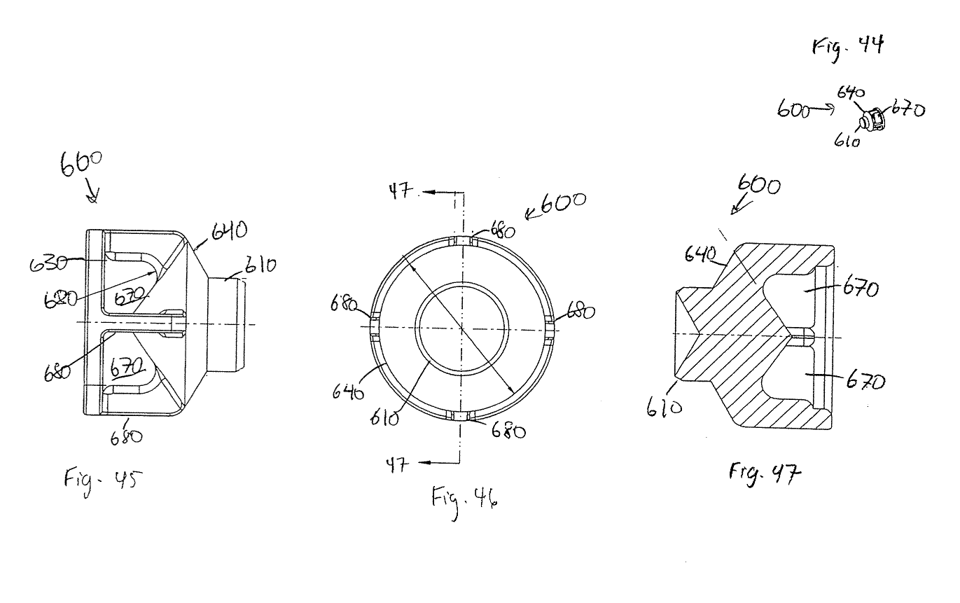

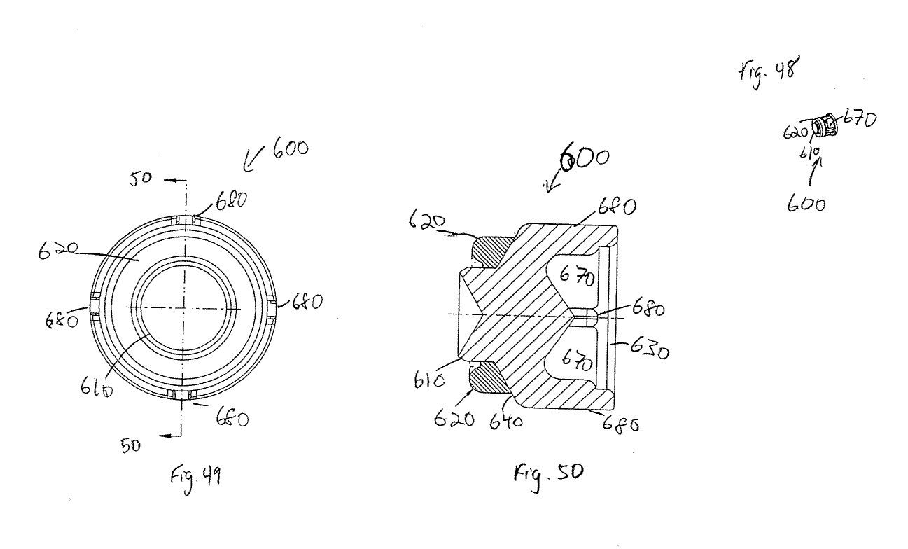

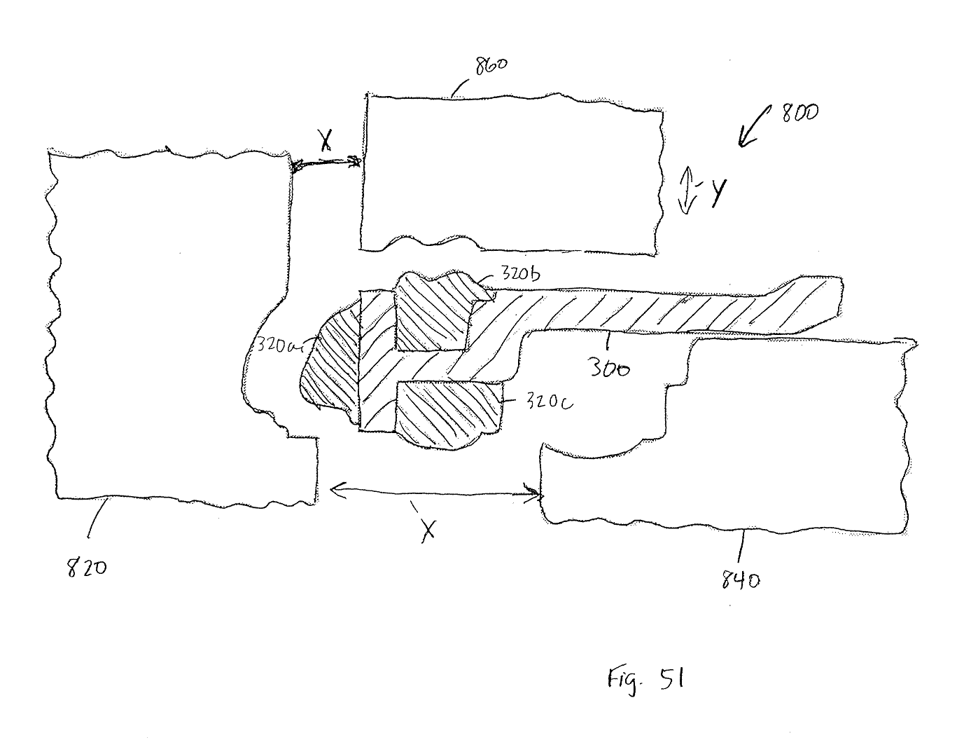

Referring now to FIGS. 2-27, body 200 is shown in more detail. Body 200 includes a housing 210, an adapter 230, a sleeve 300, and a biasing member 390. Also included is an overmold joint 250 used to attach housing 210 to adapter 230, as described further below.

Referring to FIGS. 8-14, housing 210 includes a first end 220, a housing connecting flange 280, and defines a housing flow passage 270 through which fluid can flow, as described below. Housing 210 also defines an inner shoulder 290 for engaging sleeve 300.

Housing 210 also includes lock apertures 260, a notch 260a, a clearance space 260b, and a seat 260c. These structures together form a locking structure to attach body 200 to insert 500 (see locking lugs 560 of insert 500 shown in FIGS. 31-39), as described below. This locking structure is commonly referred to as a twist-to-connect configuration including an over-centering latch. In other embodiments, other structures can be used to connect insert 500 to body 200 such as, for example, a latch assembly including one or more camming surfaces, or a locking structure such as that described in U.S. patent application Ser. No. 10/612,475.

Referring now to FIGS. 15-19, adapter 230 of body 200 includes a valve stem 400 with a stem head portion 420 that engages sleeve 300 as described below, and a flow opening 440 with flow apertures 440a. In an alternative embodiment, valve stem 400 can be configured to be hollow in a manner similar to a hollow needle arrangement.

Adapter 230 further defines a flow passage 470 in fluid communication with flow opening 440. A connecting flange 480 is attached to housing 210 by overmold joint 250, as described below. A biasing surface 490 is configured to engage biasing member 390.

Adapter 230 also includes a second end 240 that can be, for example, used to connect body 200 to a fluid transport system, such as a fluid line (not shown). For example, as shown, second end 240 includes a barbed surface structure that allows adapter 230 to be connected with a fluid line in an interference fit arrangement. Other types of connections can also be used, such as threaded arrangement.

Referring now to FIGS. 20-23, sleeve 300 is shown, including a sleeve first end 310 and a sleeve second end 330. An inner sleeve shoulder 380 is configured to engage biasing member 390. A sleeve shoulder 360 formed at sleeve second end 330 engages inner shoulder 290 of housing 210 when sleeve 300 is biased in a forward position towards first end 220 of housing 210. See FIG. 7. A sleeve flow passage 370 and flow opening 370a are also formed by sleeve 300.

Sleeve 300 also includes a recessed annular surface 340, a mold flow aperture 340a, and a mold flow opening 340b. As described below, these structures are used to form overmold seals on sleeve 300. The overmold seals create sealing structures between sleeve 300 and housing 210, and between sleeve 300 and adapter 230.

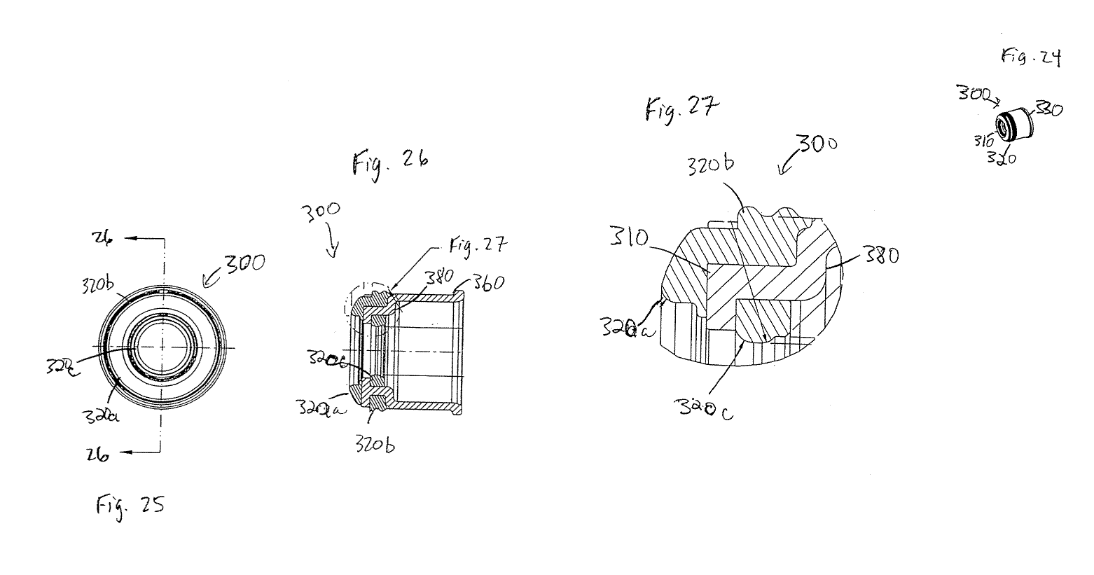

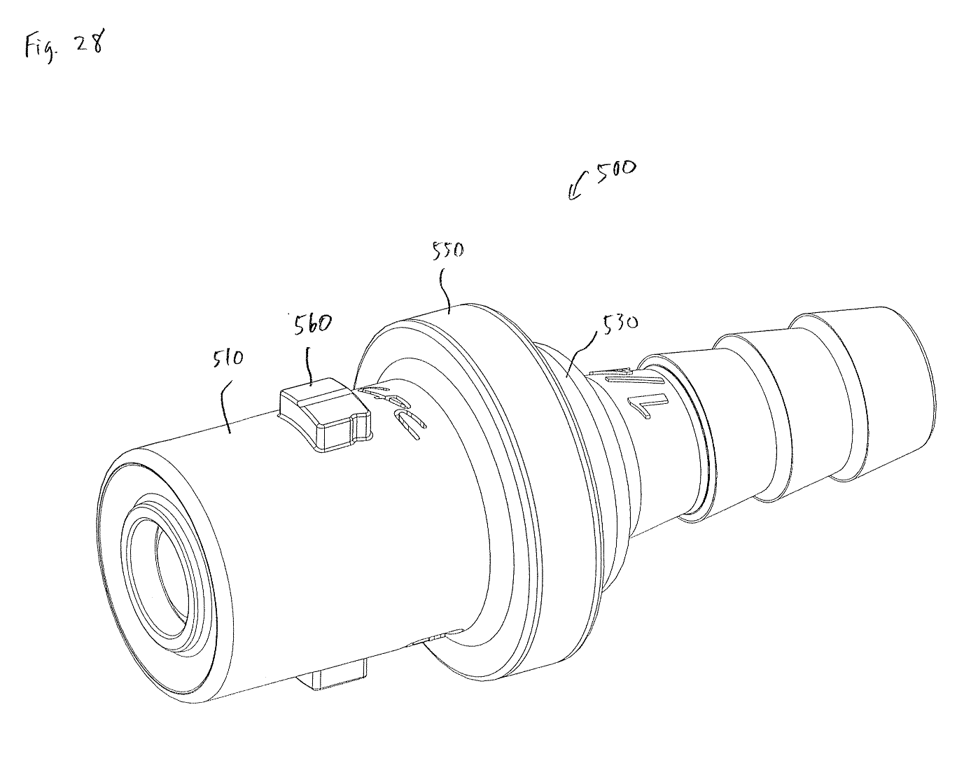

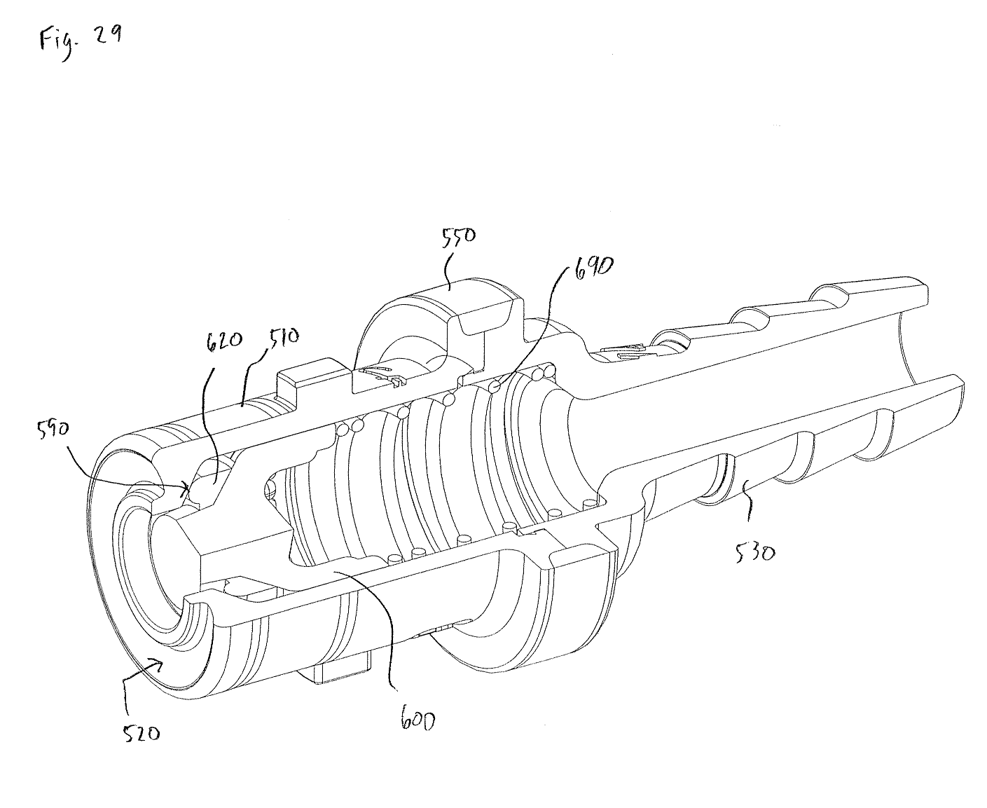

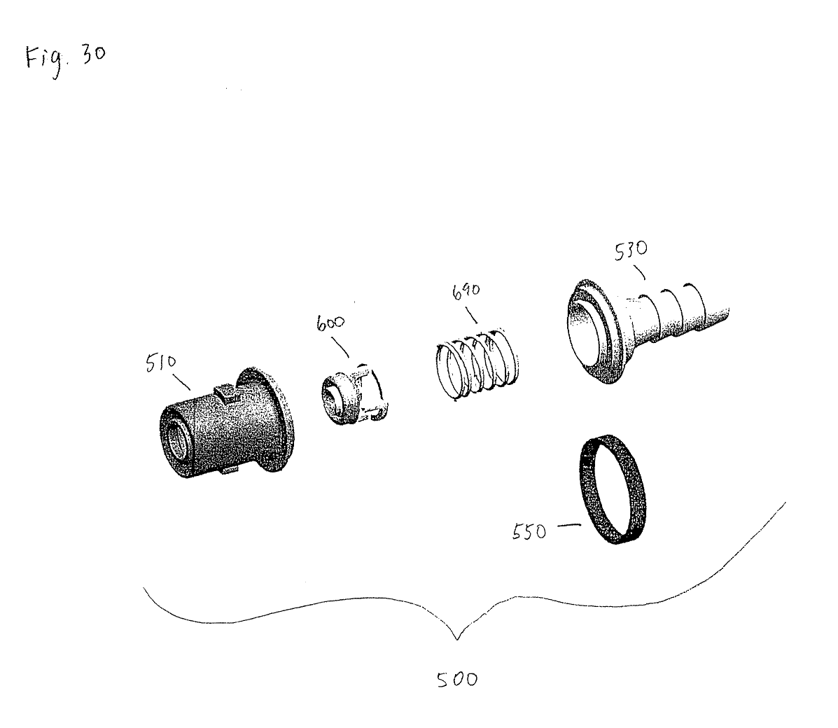

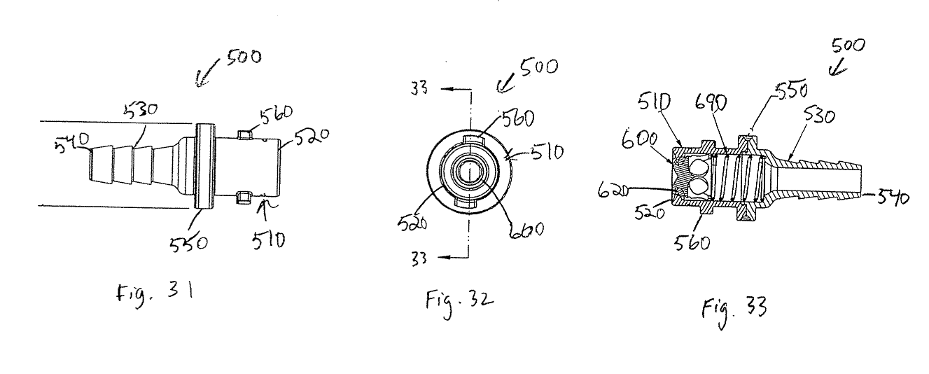

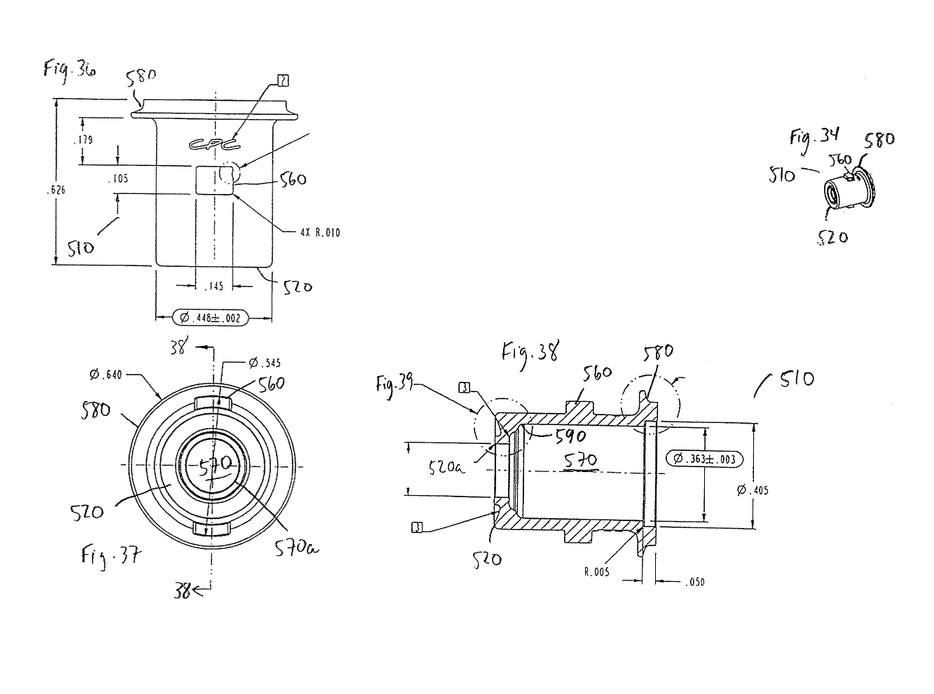

Referring now to FIGS. 1, 3, 7 and 24-27, sleeve 300 is shown with a first overmold seal 320a, a second overmold seal 320b, and a third overmold seal 320c. First overmold seal 320a is positioned to form a seal between sleeve 300 and insert housing 510 of insert 500. See FIGS. 1 and 7. Second overmold seal 320b is positioned to form a seal between sleeve 300 and housing 210 of body 200. Third overmold seal 320c, formed adjacent to flow opening 370a, is positioned to form a seal between sleeve 300 and stem head portion 420 of adapter 230 when sleeve 300 is biased in the forward position. See FIGS. 3 and 7.

In the example shown, sleeve 300, including overmold seals 320a, 320b, and 320c, is formed using the two-shot molding process described below. In other embodiments, overmold seals 320a, 320b, and 320c can be formed using other methods.

Referring to FIGS. 3, 4, and 7, biasing member 390 is positioned between biasing surface 490 of adapter 230 and sleeve 300 to bias sleeve 300 towards first end 220 of housing 210 of body 200 in the forward position. Axial force can be applied to sleeve 300 against biasing member 390 to move sleeve 300 towards second end 240 of adapter 230 when insert 500 is introduced into body 200, as described below. In one example, biasing member 390 is a metal spring, although other materials and structures can be used.

Referring now to FIGS. 28-50, insert 500 is shown. Insert 500 generally includes an insert housing 510, an insert valve 600, a biasing member 690, and an insert termination 530. Also included is an insert overmold joint 550 used to attach housing 510 to termination 530, as described further below.

Referring now to FIGS. 34-39, housing 510 defines an aperture 570a, an insert flow passage 570, and a housing connecting flange 580 configured to be attached to termination 530 by overmold joint 550, as described below. Housing 510 includes an inner shoulder 590 configured to engage overmold seal 620 formed on valve shoulder 640 of insert valve 600. A recessed surface 520c of housing 510 (see FIG. 39) functions to structurally support seal 620 as pressure is applied to insert 500 while disconnected from body 200. In addition, housing 510 includes a first end 520 with a recessed face 520a and an annular recessed surface 520b. Recessing of face 520a and surface 520b function to protect these surfaces from damage when insert 500 is disconnected from body 200.

First end 520 is sized to engage and push sleeve 300 against biasing member 390 of body 200 towards biasing surface 490 of adapter 230 when insert 500 is connected to body 200. In addition, recessed surface 520b is configured to engage first overmold seal 320a of sleeve 300 of body 200 to form a seal between housing 510 and sleeve 300 when insert 500 is connected to body 200, as described below. See FIGS. 1 and 7.

Housing 510 also includes locking lugs 560. Lugs 560 are sized to fit through clearance space 260b and ride along lock apertures 260 of housing 210 of body 200. As insert 500 is rotated relative to body 200, lugs 560 ride in lock apertures 260 until each lug 560 clears each notch 260a and is seated in seat 260c of housing 210 to connect insert 500 to body 200.

Referring now to FIGS. 40-43, termination 530 includes a second end 540 configured to be connected to a fluid transport system, such as a fluid line (not shown). Termination 530 defines a flow passage 770, and a connecting flange 780 is configured to be attached to housing connecting flange 580 by overmold joint 550, as described below. A biasing surface 790 is positioned to engage biasing member 690. See FIG. 33.

Referring now to FIGS. 44-47, valve 600 includes a valve head 610 that is positioned to extend adjacent to aperture 570a of housing 510. Valve 600 includes a valve base member 630 and a valve support portions 680, with valve flow apertures 670 formed therebetween. Valve 600 also includes valve shoulder 640.

Referring to FIGS. 48-50, an overmold seal 620 is formed on shoulder 640. Overmold seal 620 forms a seal between valve 600 and inner shoulder 590 of housing 510 when valve 600 is biased in a forward position towards first end 520 of housing 510 by biasing member 690. In the example shown, overmold seal 620 is formed using the two-shot molding process described below. Other methods of forming can also be used.

Referring to FIGS. 29, 30, and 33, biasing member 690 is positioned between biasing surface 790 of termination 530 and valve 600 to bias valve 600 towards first end 520 of housing 510 of insert 500. In one example, biasing member 690 is a metal spring, although other materials and structures can be used.

Referring again to FIG. 1, a connection between body 200 and insert 500 is created by introducing insert housing 510 of insert 500 into housing 210 of body 200. In the fully connected state as shown in FIG. 1, recessed face 520a of first end 520 of insert housing 510 engages overmold seal 320a of sleeve 300 to form a seal therebetween. In addition, sleeve 300 is pushed by insert housing 510 backwards against biasing member 390 of body 200 so that the seal formed by third overmold seal 320c of sleeve 300 with stem head portion 420 of adapter 230 is broken, thereby providing fluid communication through body 200 from flow opening 370a, through sleeve flow passage 370, through flow apertures 440a, and through flow passage 470 to second end 240 of adapter 230. In addition, in the fully connected state, stem head 420 of adapter 230 of body 200 pushes insert valve 600 backward against biasing member 690 of insert 500 so that the seal between overmold seal 620 and inner shoulder 590 of housing 510 is broken, thereby providing fluid communication through valve flow apertures 670 to insert flow passage 570, and through flow passage 770 to second end 540 of termination 530. In this manner, a fluid-tight channel is formed from second end 240 of body 200 to second end 540 of insert 500.

In addition and as noted above, when insert 500 is connected to body 200, locking lugs 560 fit through clearance space 260b and ride in lock apertures 260 of housing 210 of body 200. As insert 500 is rotated relative to body 200, lugs 560 ride in lock apertures 260 until each locking lug 560 clears a respective notch 260a and is seated in seat 260c of housing 210 to connect insert 500 to body 200. To remove insert 500 from body 200, engagement between lug 560 and seat 260c of housing 210 is broken by applying a slight axial force to push insert 500 and body 200 together and rotating insert 500 relative to body 200 in an opposite direction so that lugs 560 are unseated from seat 260c, clear notch 260a, and reach clearance space 260b to allow insert 500 to be removed from body 200.

Because there is only a small volume defined between body 200 and insert 500 when connected, there is little “spillage” released when the insert 500 is disconnected from the body 200. In addition, there is only a small volume of air or “inclusion” introduced into the system when the body 200 and insert 500 are connected.

In the example shown, body 200 and insert 500 of coupling assembly 100 are sized to form a ⅛ inch, ¼ inch, ⅜ inch, or ½ inch size connection. Other sizes for assembly 100 can be used.

Referring now to FIG. 51, an example system 800 and method for forming sleeve 300 and overmold seals 320a, 320b, and 320c on sleeve 300 are shown. System 800 includes cores 820, 840 and cam 860 that are used to form sleeve 300 and overmold seals 320a, 320b, and 320c using a two-shot molding process. Generally, a two-shot molding process uses two injection units that inject first and second molding materials during a molding processes. The resulting process enables the first and second materials to be mechanically bonded.

As shown in FIG. 51, cores 820, 840 move in a direction X, and cam 860 moves in a direction Y to form a cavity. Initially, sleeve 300 is formed during a first shot of the molding process. Next, seals 320a, 320b, and 320c are formed during a second shot of the molding process. For example, material can be introduced through mold flow aperture 340a and opening 340b of sleeve 300 to form seals 320a, 320b, and 320c.

There are advantages associated with using the two-shot molding process to form sleeve 300. For example, sleeve 300 including seals 320a, 320b, and 320c can be formed in a single process, thereby increasing efficiency. In addition, seals 320a, 320b, and 320c can replace the typical o-rings used to form seals between different components of connectors in prior coupling assemblies, thereby reducing the number of components and manufacturing time for the assemblies and increasing reliability for the sealing surfaces. In addition, the molding process can result in the formation of a chemical bond between sleeve 300 and seals 320a, 320b, and 320c, thereby increasing structural integrity.

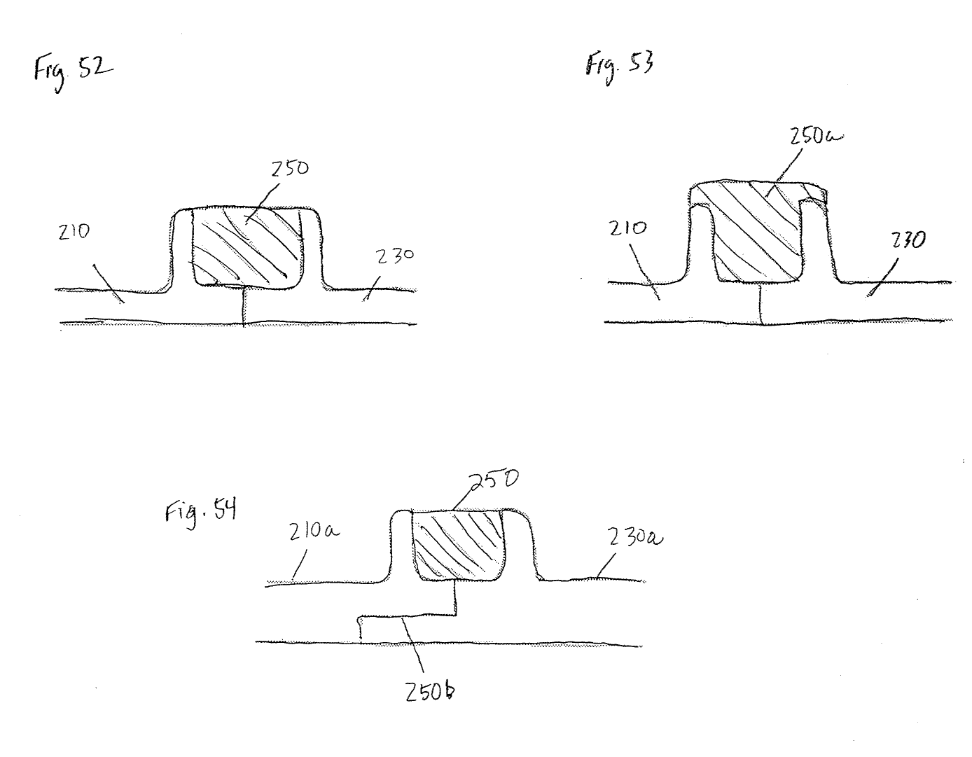

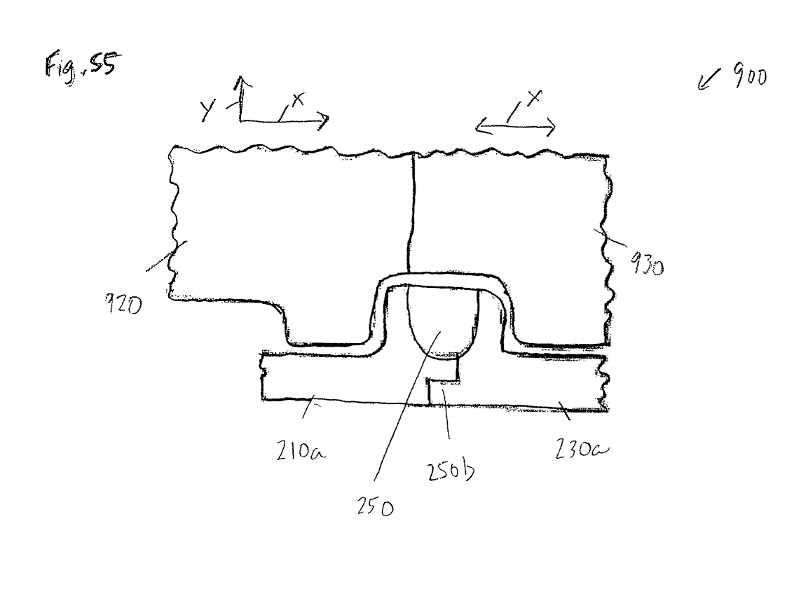

Referring now to FIGS. 52-54, example configurations of overmold joint 250 used to attach housing 210 to adapter 230 of body 200 are shown. In FIG. 52, housing 210 and adapter 230 abut, and overmold joint 250 is formed flush therebetween to attach housing 210 to adapter 230. In the alternative shown in FIG. 53, overmold joint 250a is formed to extend beyond the cavity formed between housing 210 and adapter 230. This configuration can, for example, provide additional joint strength and improved aesthetics. In the alternative in FIG. 54, housing 210a and adapter 230a include a mating structure 250b. The mating structure 250b allows adapter 230a to partially support housing 210a during formation of overmold joint 250.

Referring now to FIG. 55, an example system 900 and method for forming overmold joint 250 are shown. Generally, system 900 utilizes insert molding, in which a solid preform is placed in the mold, and a polymer is shot around the preform. The preform and polymer are welded during the molding process. In FIG. 55, a core 930 moves in direction X, and a cam 920 moves in both directions X and Y to form a cavity between housing 210a and adapter 230a. Once in place, a polymeric material is injected to form overmold joint 250. Overmold joint 250 is welded to housing 210a and adapter 230a during the injection molding process.

In the examples shown, insert valve 600 and overmold seal 620 on valve shoulder 640 are formed using a two-shot molding process similar to that described above for overmold seals 320a, 320b, and 320c. In addition, overmold joint 550 used to attach housing 510 to termination 530 of insert 500 can be formed in a similar manner to that described above with respect to overmold joint 250. In some embodiments, the process of creating overmold joint 550 can be integrated with molding of one or more other components.

In the illustrated embodiment, adapter 230 and termination 530 are configured so that an outer surface of each component is identical so that the same tooling can be used to mold both components. This can reduce costs for the tooling used to mold these components.

In the examples shown, most components of body 200 and insert 500 are molded using a thermoplastic. For example, housing 210, sleeve 300, and adapter 230 of body 200 and insert housing 510, valve 600, and termination 530 of insert 500 can be molded from polypropylene. Other types of plastics, such as Acrylonitrile-Butadiene-Styrene (“ABS”), acetal, polycarbonate, polysulfone, and polyethylene, can also be used. Advantageous of such materials include one or more of the following: chemical resistance and/or compatibility; decreased cost; increased strength and dimensional stability; and compatibility with most sterilization methods, including Gamma, e-beam, and ethylene oxide sterilization.

In the examples shown, the overmold portions of assembly 100, such as overmold seals 320a, 320b, 320c, and 620, and overmold joints 250 and 550, are molded using a thermoplastic. In some embodiments, the thermoplastic is a thermoplastic elastomer (“TPE”) or a thermoplastic vulcanizate (“TPV”). In one example, TPV is formed using a resin sold under the trademark SANTOPRENE™ by Advanced Elastomer Systems, LP of Akron, Ohio. Other materials, such as VERSALLOY® manufactured by GLS Corporation of McHenry, Ill., or TEKBOND® manufactured by Teknor Apex Company of Pawtucket, R.I., can also be used.

The above specification provides a complete description of the composition, manufacture and use of the improved coupling assemblies in accordance with the principles of the present inventions. Since many embodiments of the inventions can be made without departing from the spirit and scope of the inventions, the present inventions are not limited to the example embodiments described herein.

What is claimed is:

1. A coupler for a coupling assembly, the coupler comprising:
a housing defining an internal bore;
a sleeve positioned in the bore of the housing; and
a first overmold seal formed to create a sealing engagement between the sleeve and the housing.

2. The coupler of claim 1, further comprising:
a stem located in the internal bore of the housing; and
a second overmold seal formed to create a sealing engagement between the sleeve and the stem.

3. The coupler of claim 1, further comprising a third overmold seal formed to create a sealing engagement with a surface of a mating coupler.

4. The coupler of claim 1, further comprising:
a second overmold seal formed to create a sealing engagement between the sleeve and a stem; and
a third overmold seal formed to create a sealing engagement with a surface of a mating coupler.

5. The coupler of claim 4, wherein the first, second, and third overmold seals are formed using a single shot process.

6. The coupler of claim 5, wherein the sleeve is formed in a first shot of a two shot molding process, and wherein the first, second, and third overmold seals are formed on the sleeve in a second shot of the two shot process.

7. The coupler of claim 1, further comprising an adapter, wherein the adapter is coupled to the housing by an overmold joint.

8. A coupler for a coupling assembly, the coupler comprising:
a housing including a first end, a second end, and defining an internal bore, wherein the first end defines a recessed sealing surface;
a termination attached to the second end of the housing; and
a valve positioned in the bore of the housing.

9. The coupler of claim 8, further comprising:
a first overmold seal formed to create a sealing engagement between the valve and the housing.

10. The coupler of claim 9, wherein the valve is formed in a first shot of a two shot molding process, and wherein the first overmold seal is formed on the valve in a second shot of the two shot process.

11. The coupler of claim 9, further comprising an overmold joint formed to couple the housing and the termination.

12. A method of forming a coupler, the method comprising:
molding a sleeve of the coupler, the sleeve defining an interior surface, an exterior surface, a first end, and a second end; and
overmolding a first seal on the exterior surface of the sleeve to seal against a wall forming an internal bore in a housing of the coupler.

13. The method of claim 12, further comprising overmolding a second seal on the interior surface of the sleeve to seal against a stem of the coupler.

14. The method of claim 12, further comprising overmolding a third seal on the first end of the sleeve to seal against a surface of a mating coupler.

15. The method of claim 12, further comprising:
overmolding a second seal on the interior surface of the sleeve to seal against a stem of the coupler; and
overmolding a third seal on the first end of the sleeve to seal against a surface of a mating coupler.

16. The method of claim 15, further comprising overmolding the first, second, and third seals on the sleeve using a single shot process.

17. The method of claim 15, further comprising:
forming the sleeve in a first shot of a two shot process; and
overmolding the first, second, and third seals in a second shot of the two shot process.

18. The method of claim 12, further comprising:
placing the sleeve in the internal bore of the housing;
coupling an adapter to the housing; and
overmolding a joint between the housing and the adapter.

19. The method of claim 1S, further comprising positioning a spring within the housing between the sleeve and the adapter to force the sleeve away from the adapter.

20. The method of claim 19, further comprising allowing the first seal of the sleeve to form a seal against the wall of the internal bore in the housing as the sleeve is moved axially within the housing.
